(19) United States
(12) Patent Application Publication
(10) Pub. No.: US 2009/0120103 A1
(43) Pub. Date: May 14, 2009

(54) METHOD AND APPARATUS FOR SUB SEA POWER GENERATION

(75) Inventors: Tom Grimseth, Oslo (NO); John Daniel Friedemann, Gjettum (NO); Christian Borchgrevink, Langhus (NO); Ivar Balk, Jar (NO)

Correspondence Address: VENABLE LLP, P.O. BOX 34385, WASHINGTON, DC, 20043-9998, US

(73) Assignee: VetcoGray Scandinavia AS, Billingstad (NO)

(21) Appl. No.: 12/158,733

(22) PCT Filed: Dec. 21, 2006
(86) PCT No.: PCT/IB06/03737

§ 371 Date: Nov. 17, 2008

Related U.S. Application Data
(60) Provisional application No. 60/752,059, filed on Dec. 21, 2005.
(60) Provisional application No. 60/856,293, filed on Nov. 3, 2006.

(51) Int. Cl. F02C 7/32; F04B 17/00

(52) U.S. Cl. 60/805; 60/772; 417/405

(57) ABSTRACT

A method for generating power at sub sea level. An oxidizing fluid and oxidizer are fed separately for mixing at a sub sea station. The oxidizing fluid and oxidizer are chosen for chemical reaction in situ under the release of energy. The energy so produced is fed to drive means operated by at least one of heat, kinetic energy, pressure and electricity, and operative to drive sub sea processes or/and sub sea production equipment. An apparatus for generating power at sub sea level. The apparatus includes separate supplies of an oxidizing fluid and an oxidizer for mixing at a sub sea station. The oxidizing fluid and oxidizer are chosen for chemical reaction in situ under the release of energy. A feed for feeding the energy so produced to a drive operated by at least one of heat, kinetic energy, pressure and electricity.

### FIELD OF THE INVENTION

The present invention relates to methods and apparatuses, which are useful for in situ power generation at sub sea level. In particular, the invention relates to methods and apparatuses operative for driving sub sea processes and/or sub sea production equipment, wherein an oxidizing fluid and an oxidizer are employed for the power generation.

### BACKGROUND AND PRIOR ART

Production of hydrocarbons from sub sea wells requires various forms of control to be exercised over the flow of fluids produced by the wells. All such control means require supply of power to the production site for operation of valves, motors, electronic circuitry and other installations.

Traditionally, transmission of power to a sub sea production station has been in the form of electrical power, transmitted on insulated copper wires, and fluid power transmitted in small bore tubes. Transmission has been from a control station on the beach or host platform to the sub sea station.

Lately the consumption of power for various control purposes at a sub sea production station has increased significantly. This is related to introduction of more power consuming instrumentation, heating systems and fluid pressure boosting systems, all introduced for improved flow assurance and often associated with long flow line systems. The increase in power consumption has involved drastically enhanced electrical power system. Transmission of hydraulic power is becoming less attractive as power levels increase and at the same time (typically) distance between the control station and the production station also increases.

Historically electrical power transmission systems sub sea have been the source of many operating problems. This is particularly related to design of cable terminations, penetrators and wet mate connector systems. The very high reliability achieved for termination and connection of pipeline systems have not been achieved for electrical power systems. Whereas pipeline terminations and connections can be effected by means of all metal designs, this approach is not possible for electrical power systems, which need electrical insulation materials, i.e. non-metallic materials. Many such materials and associated equipment designs are subject to ingress of water molecules and, in some cases, even ingress of water of considerable salinity content, thus reducing initial good insulation values to the point that inoperable conditions result. Many substantial improvements have been made in recent years, but problems are still encountered, especially for higher voltages.

The sub sea oil and gas industry has in some instances experienced success by introducing redundant systems for some critical functionality, such that if one system fails the other can maintain operation. However, several redundancy schemes have failed because of common failure modes, i.e. design or fabrication processes, such that the same failure has occurred in two mutually redundant components at essentially the same time. Successful solutions to achieving true redundancy schemes are/should be based on two independent and entirely different technologies. Such solutions reduce the potential for system failures caused by systematic design or fabrication errors. Independently designed systems (in particular independent technologies) should not share design errors.

Further, transfer of unprocessed well streams in a flow line requires either maintaining a certain minimum temperature in the well fluids or other forms of preventing formation of hydrates and/or wax/asphaltenes, e.g. by adding inhibitors such as MEG or methanol (hydrates), or typically diesel in the case of wax, or other chemicals.

Most hydrate and wax management strategies are based on maintaining the minimum temperature (pressure dependant), typically by means of thermal insulation. Thermal insulation of flow lines tends however to be costly, especially in deep waters. Heating is also used, mostly for the transient condition of the transfer, as heating in the steady state condition tends to be costly (e.g. electrical power).

A source of low cost heat available at the production site and/or at intermediate sites between the production site and the destination could facilitate transfer at higher temperatures and higher pressures with use of less costly insulation.

For some reservoirs the wellhead flowing pressure of the well stream is insufficient to propel the fluid over long distances or up long, essentially vertical, riser sections, as both static head and frictional forces of flow hamper effective fluid transfer.

Both multiphase boosting of unprocessed well streams and compression of essentially dry gas are presently planned, the latter consuming by far the higher amount of power. Installations in the range 50-100 MW are considered for gas compression and typically 2-10 MW for multiphase boosting of essentially liquid phases.

Sub sea electrical power transmission has made significant progress over the last 10 years with such components as penetrators, wet mate connectors and transformers now being rated at some 36 kV, some components even beyond that level. Frequency converters for large power ratings are being developed. However, for very large power transmissions over long distances (e.g. more than 500 km) AC transmissions by means of sub sea cables will be subject to constraints and DC will be the only practicable electrical power transmission. DC to AC conversion in the 145-300 kV range for very high power ratings is not technically trivial and could be very costly. It is also uncertain what range of reliability can be achieved with this type of equipment.

Thus both for power drive of compressors/booster pumps and for heating on a large scale and at long offsets electrical power has certain constraints in a sub sea scenario.

As an alternative, transmission of power in the form of combustible chemicals could be considered.

When 1 kg of hydrogen reacts with 8 kg of oxygen (oxy-hydrogen gas) some 14 MJ of heat is generated, i.e. for 9 kg of oxy-hydrogen gas burned per second the power generation is approximately 14 MW. Similarly combustion of 1 kg per second of hydrogen peroxide will generate a heat of some 2.5 MW.

For purposes of heating only this order of magnitude of heat elevates a significant well mass stream to the required hydrate free regime. For purposes of compression/boosting significantly less power would be transformed to rotary power, the rest being lost in the poor efficiency of a steam plant or used for heating purposes.

For sites accommodating Liquid Natural Gas (LNG) trains or on platforms there is often natural gas available at favourable cost. Thus hydrogen can be produced also at favourable cost by means of reforming of natural gas. Hydrogen is consumed on a very large scale world wide for fertiliser plants and crackers. Albeit not a simple process (natural gas to hydrogen) it is well proven and predictable both technically and commercially.

Production of hydrogen by means of reforming can be described as follows:

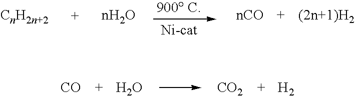

Oxygen is most economically produced in large quantities by means of cryogenic techniques, although other means are also available. Thus at typical LNG sites both hydrogen and oxygen can be produced economically.

Production of hydrogen peroxide is based on electrolysis and the fuel is traded in large quantities at a cost in order of magnitude 1 USD per kg. With a specific heat of only 2.5 MJ per kg this fuel cannot compete with the economy of hydrogen as a cost effective energy carrier on a large scale. Hydrogen peroxide offers the advantage that it can be transported in liquid form (water based) and in a single supply line, thus making for a cost effective transport from the land based or topsides site to the sub sea production site, and also very compatible with sub sea technology in general. It is only economical for smaller installations where the fuel economy is not critical.

Reforming of natural gas to produce hydrogen requires very significant input of energy in the form of heat. In general it is considered that 25% of the natural gas has to be burned to generate the required heat assuming that is the only heat source. On an LNG site with massive gas turbine installations for driving compressors it is also conceivable that some of the heat could be taken from the turbine exhaust, which is basically free of charge.

In considering the features of this invention the following data can be useful:
Combustion of oxy-hydrogen gas produces steam at 2420° C.
Combustion of H₂ in air produces gases at a temperature of 1900° C.
100% hydrogen peroxide produces combustion products at temperature of 1012° C.
98% hydrogen peroxide produces combustion products at temperature of 952° C.
95% hydrogen peroxide produces combustion products at temperature of 892° C.

### SUMMARY OF THE INVENTION

The invention aims at providing a power source at a sub sea station, not based on electrical power transmission from a remote control/power station (land based station) and/or host platform.

The stated object is met in methods and apparatuses as claimed in the appended claims.

The power is provided by means of a chemical reaction between hydrogen gas and oxygen gas (or some other suitable combination of oxidizing fluid with oxidizer and providing a useful power output as well as water as waste product. The latter is preferably discharged into the ambient sea with no harmful chemical effects. The conversion of the two gases or fluids to useful power can be in the form of combustion producing a high temperature phase and/or by means of direct conversion to electrical power by means of a fuel cell, and/or by other reactions of the two gases or fluids. The fluids are either transported to the sub sea station by means of dedicated tubes/pipes between the control station and the production station, or stored in dedicated pressure vessels at the production station.

Hydrogen gas and oxygen gas, or alternatively, liquid hydrogen peroxide is conducted to a sub sea heating/boosting/compression site where combustion takes place to produce steam (in the case of hydrogen and oxygen forming oxy-hydrogen gas, i.e. H₂+O₂), or steam plus oxygen (in the case of hydrogen peroxide, i.e. H₂O₂). The steam generated is used to heat the well stream in a heat exchanger and/or drive a steam turbine, which in turn drives a compressor or pump (multiphase or single phase depending on application) to boost the pressure of the well stream.

In brief, the present invention provides on one hand a method by which power is generated at sub sea level, comprising the steps of:
feeding an oxidizing fluid and oxidizer separately for mixing at a sub sea station, wherein the oxidizing fluid and oxidizer are chosen for chemical reaction in situ under the release of energy;
feeding the energy so produced to drive means operated by at least one of heat, kinetic energy, pressure and electricity, and operative for driving sub sea processes or/and sub sea production equipment.

Advantageously, hydrogen is suggested as oxidizing fluid and oxygen is suggested as oxidizer. Alternatively, the oxidizing fluid may be hydrogen peroxide and the oxidizer is a catalyst.

In one embodiment, a combustion chamber is provided sub sea for combustion in situ of the mixture of oxidizing fluid and oxidizer. In another embodiment, the oxidizing fluid and the oxidizer are supplied to a fuel cell provided sub sea and operative for producing electrical power in situ. In yet another embodiment, the method involves introducing of combustion gases directly into a hydrocarbon product stream in a flow line from an oil and/or a gas well.

In still another embodiment, combustion gases are discharged from a combustion chamber to an inlet of a steam turbine connected as drive mechanism to a compressor or pump, the compressor/pump being operative for boosting the pressure of a hydrocarbon product stream in a flow line from an oil and/or a gas well. In another embodiment, the method involves the steps of discharging combustion gases to a heat exchanger, wherein heat from the combustion gases is transferred to a hydrocarbon product stream in a flow line from an oil and/or a gas well. In a further embodiment, the method involves the step of discharging combustion gases into a separator unit by which a liquid water phase is removed from the combustion gases.

Advantageously, the separated liquid water phase is mixed with the combustion gases such that steam is produced upstream of the turbine inlet.

The method according to the present invention advantageously comprises the steps of providing a fuel cell in a pressure vessel at sub sea level, and subjecting the fuel cell to a pressure which is higher than the ambient sea water pressure. Pressurizing the fuel cell may be accomplished through one of oxidizing fluid and oxidizer supplied to the pressure vessel and fuel cell. Output water from the fuel cell may be discharged to the ambient sea.

On the other hand, the present invention provides briefly an apparatus by which power is generated at sub sea level, comprising:
separate supplies of an oxidizing fluid and an oxidizer for mixing at a sub sea station, wherein the oxidizing fluid and oxidizer are chosen for chemical reaction in situ under the release of energy;
means for feeding the energy so produced to drive means operated by at least one of heat, kinetic energy, pressure and electricity, and operative for driving sub sea processes or/and sub sea production equipment.

The oxidizing fluid and oxidizer may be supplied from a land-based station or from a host platform at sea surface. Alternatively, the oxidizing fluid and oxidizer are supplied from pressure vessels at sub sea level.

The feeding means is preferably at least one of a combustion chamber, a turbine, and a fuel cell.

The drive means powered through chemical reaction between an oxidizing fluid and an oxidizer is preferably at least one of a turbine/compressor unit, a DC/AC converter and a heat exchanger.

In one embodiment, a combustion chamber is provided wherein the oxidizing fluid and oxidizer are mixed and combusted for producing combustion gases. The combustion chamber has an outlet for combustion gases, which in one embodiment is in flow communication with a hydrocarbon product stream in a flow line from an oil and/or a gas well.

In another embodiment, the combustion chamber is arranged with an outlet for combustion gases in flow communication with a heat exchanger transferring heat from the combustion gases to a hydrocarbon product stream in a flow line from an oil and/or a gas well.

In yet another embodiment, the combustion chamber is arranged with an outlet for combustion gases connected to an inlet of a turbine, the turbine being connected as drive mechanism to a compressor or pump which is in flow communication with a hydrocarbon product stream in a flow line from an oil and/or a gas well. An outlet from the turbine may be connected to a heat exchanger, and alternatively or in addition, connected to a separator unit operative for separating a liquid water phase from the combustion gases. Advantageously, the separator is arranged in flow communication with the discharge of combustion gases from the combustion chamber, and operative for introducing water in the combustion gases upstream of the turbine inlet.

In the embodiment comprising a separator unit, the separator may be arranged to comprise essentially vertical heat exchanger pipes penetrating an upper portion of a pressure vessel forming a separator/heat exchanger shell such that the heat exchanger pipes form closed volumes, filled with a substance suitable for liquid/gas phase conversion at the temperatures prevailing in the separator/heat exchanger volume, and suitable for the reverse process at temperatures in the range of the ambient, such as ambient sea, such that at least one, preferably each of the sealed pipes constitute a separate heat exchanger system without moving parts.

In another embodiment, the apparatus comprises a fuel cell operative for producing electrical power by chemical reaction of the oxidizing fluid and the oxidizer, the fuel cell contained in a pressure vessel and pressurized within said pressure vessel to a pressure which is higher than the ambient sea water pressure. In this embodiment, one of the separately supplied oxidizing fluid and oxidizer may be supplied to the pressure vessel for pressurizing the fuel cell. Pressurizing of the pressure vessel may alternatively be accomplished through a separate media.

In addition, a reaction vessel may be contained in the pressure vessel and comprising internal piping by which the oxidizing fluid and/or the oxidizer is preheated to a temperature suitable for optimal operation of the fuel cell. The piping of the reaction vessel may be arranged for transfer of heat from fluids to be discharged from the fuel cell to fluids which are supplied to the fuel cell.

The present invention thus involves the use of an oxidizing fluid and an oxidizer for power production at sub sea level according to the method briefly outlined above. Hydrogen or hydrogen peroxide is advantageously used as the oxidizing fluid, and oxygen or a catalyst may be used as the oxidizer.

In one embodiment, the oxidizing fluid and oxidizer are employed for the production of electrical power in a fuel cell at sub sea level. In another embodiment, the oxidizing fluid and oxidizer are employed for driving a turbine/compressor assembly at sub sea level. In yet another embodiment, the oxidizing fluid and oxidizer are employed for driving a heat exchanger.

The oxidizing fluid and oxidizer may advantageously be used for enhancing a flow of hydrocarbon product through a flow line in the sub sea production of oil and/or gas.

### BRIEF DESCRIPTION OF THE DRAWINGS

Further advantages as well as advantageous features of the inventive method and apparatus will appear from the following description and the appended claims. It will be understood that features illustrated in the drawings as well as defined in the description and claims, applied separately or arbitrarily combined, each contributes beneficially to the invention.

FIG. 1 illustrates an energy transfer and power generation system, burning oxy-hydrogen gas in a combustion chamber and using the output steam to drive a turbine;

FIG. 2 illustrates a simple system for heating by means of burning oxy-hydrogen gas in a combustion chamber and heating a well stream in a heat exchanger, and

FIG. 3 is a schematic representation of a fuel cell feeding a DC to DC/AC converter.

### DETAILED DESCRIPTION OF PREFERRED EMBODIMENTS OF THE INVENTION

For the purpose of this application only use of oxy-hydrogen gas is described although very similar techniques could be used for hydrogen peroxide with the exception that combustion of hydrogen peroxide produce oxygen in addition to liquid water. This difference has consequences for the efficiency of the power system (discharge to a back pressure of the ambient sea water, but the basic operation of an oxy-hydrogen based power system and a hydrogen peroxide based power system, are similar. Thus the most economical large scale system is described.

In the following a power transmission and conversion system is described with reference to FIG. 1.

A hydrogen line 1 and an oxygen line 2 carry gas from the beach or from a sea level platform to the mixing and combustion chamber 3 through check valves (not shown) on the production location sub sea. The mixture gas (oxy-hydrogen) is ignited by conventional means (not shown).

The steam produced is discharged to the inlet of a steam turbine 4 which drives a compressor 5 (or, alternatively a multiphase pump as required). The compressor is fed produced gas through pipe 6 and discharges high pressure gas to the flow line 7. The discharge steam from the turbine 4 is conducted to a heat exchanger/separator 10 through discharge pipe 18. The heat exchanger/separator 10 is a pressure vessel operating at a pressure typically in the domain 0.5 to 2 bara and pressure retaining the ambient sea water 17. Pipes 9 are sealed heat exchangers operating in a phase conversion mode, the hot interior of 10 heating the liquid phase of the coolant liquid to gas phase, rising to the top of the pipe and being cooled to liquid phase running down the outer walls of the pipe. This type of heat exchanger is commonplace and well proven, also in a sub sea environment. A variety of coolant fluids are commercially available from general process industries. This type of heat exchanger has no moving parts, is space effective and suitable for prolonged sub sea operation without maintenance operations.

The separator will collect liquid water, condensed from the gas state, at the bottom and some excess hydrogen or oxygen (depending on the accuracy of the flow control of both) in the rest of the volume. Both phases need to be removed form the heat exchanger/separator chamber 10.

Calculations show that the gas compressor 15 required for removal of excess gas phase from the separator/heat exchanger 10 and the pump 12 required for removal of the water phase are both very moderate in power rating compared to the rating of the main turbine 4. Assuming perfect mixture of oxy-hydrogen at perfect ratio the gas compressor 15 is superfluous, but this is not likely to happen in a practical installation.

One practical problem related to operation of the gas turbine 4 is that the combustion temperature of oxy-hydrogen gas is very high and could require special materials for the turbine blades and other components. This requirement is most undesirable, thus in order to use standard steam turbine technology, the condensed water phase, or parts of it is removed via line 11 and boosted in the pump 12, conducted via line 13, and mixed at 14 with the combustion gases discharged from 3, thus producing a larger mass flow of steam at a lower temperature. Excess condensed water is discharged to the ambient sea 17 (discharge circuit not shown).

It should be noted that the shown process is grossly simplified for the purposes of illustration. A practical design requires a number of process elements such as isolation valves, control valves and a range of instruments of various types. However, all the required elements are currently available as sub sea design or standard industrial designs suitable for marine applications. As an example a large sub sea process control valve has recently been qualified for sub sea use in conjunction with sub sea separation systems. Level detection systems for the water phase/gas phase interface in pressure vessel 10 have been demonstrated over several years of successful operation on the sea bed.

Several of the components shown on FIG. 1 require thermal insulation, probably one of the most significant challenges related to the subject invention. However, the industry has made significant progress in this area over the last 10 years, and, albeit not technically trivial, suitable materials and processes are now available on a commercial basis.

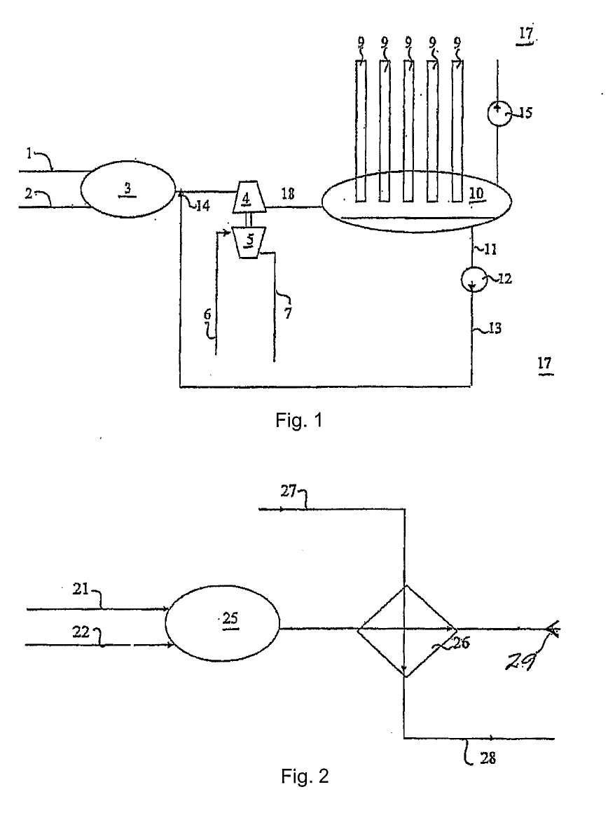

In the following a simple heating system is described with reference to FIG. 2.

A hydrogen line 21 and an oxygen line 22 carry gas from the beach or platform through check valves (not shown) to the combustion chamber 25 on the production location. The mixture gas (oxy-hydrogen) is ignited by conventional means (not shown).

The steam produced is conducted to a heat exchanger 26 and cooled by a well stream 27. Liquid water and any gas surplus are discharged through a check valve 29. The heated well stream is discharged into a flow line 28.

In its simplest form the described heating system has no moving parts sub sea and requires no control functionality sub sea except isolation valves in the supply lines (not shown).

In a practical application it would be desirable to mix the gases at the optimal ratios thus producing as close to 100% steam with a minimum of surplus gas of either type discharged into the ambient. This would require flow monitoring and flow control in each line. These are proven techniques in a sub sea environment and can be made reliable for the case of clean single phase fluids.

It would for some applications be very attractive to discharge the steam directly into the well stream. This would only be acceptable for exceptional cases using very high metallurgy in the production and system as free oxygen molecules in the well fluids is unacceptable and free hydrogen molecules would increase the partial pressure of hydrogen, which can cause hydrogen induced embrittlement of pipeline welds.

The two processes illustrated in FIG. 1 and FIG. 2 could be combined and the waste energy from the steam turbine 4 of FIG. 1 could be discharged into the heat exchanger 26 of FIG. 2 such as to use the waste energy for heating of the process fluids. Production of dry gas is mostly based on cold transfer, thus the combination of the two processes are mostly relevant to cases of multiphase boosting of oil dominated production fluids, where hot transfer of the produced fluids is normally preferred.

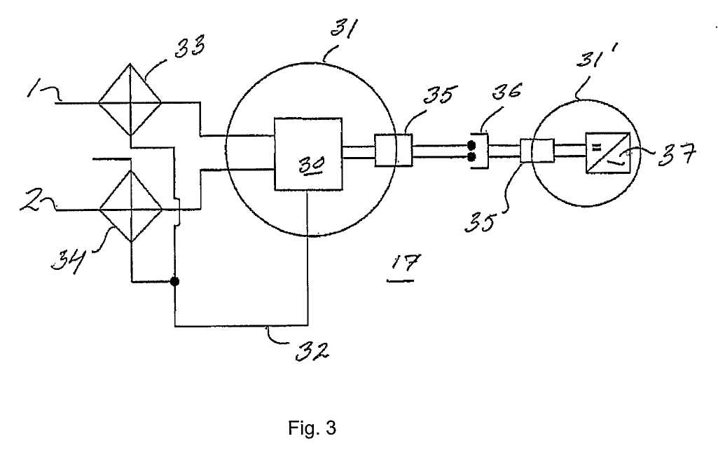

One embodiment of the invention, illustrated in FIG. 3, is to arrange a fuel cell 30 located in a pressure vessel 31 to provide the chemical reaction between hydrogen and oxygen. Thus, in the fuel cell, the hydrogen and oxygen combine into water while energizing the fuel cell from which electrical power may be supplied to drive sub sea processes and/or production equipment. Fuel cell technology is by now well established within other technical areas. Some modifications to current designs are required to be able to expose a fuel cell to a high environmental pressure, but investigations suggest that this is practically feasible. Typical fuel cells would even achieve higher throughput at elevated pressures.

In one preferred embodiment the fuel cell is pressurized, typically by means of one of the input gases/fluids 1 or 2, to a pressure just above ambient pressure in the ambient sea water 17 at operating conditions, thus facilitating discharge of the waste water output 32 to the ambient sea water 17 without any further pressure boosting and thus without the complications of moving mechanical parts. Either of the input gases/fluids 1,2 could in principle be used to pressurize the fuel cell 30 in the pressure vessel 31. Using the oxygen phase 2 would appear particularly attractive such as to avoid exposure of the pressure vessel 31 to a high partial pressure of hydrogen with the inherent embrittlement problems associated with welding of high tensile steels 8 in combination with exposure to high partial pressures of hydrogen.

Operation of a fuel cell 30 on the sea bed under pressure is thus quite feasible. However, the temperatures typically found at sea bed conditions 17 are significantly lower than the optimum operating temperature of a typical fuel cell 30. The discharge water 32, which is discharged at typically 80 degrees, will naturally be used to heat the gases/fluids by means of heat exchangers 33,34 but this energy is not sufficient to reach the optimum operating temperature.

There are several ways to mitigate this temperature problem:
A part of the electrical output of the fuel cell is used to heat the input gases/fluids in heat exchangers (inherently requiring a higher power throughput), not shown;
The tubes/pipes carrying the input gases/fluids can be coiled around a manifold or valve tree (Xmas tree) pipe carrying produced fluid and under thermal insulation, such as to be heated by the produced fluids, also not shown.

Many sub sea installations also have “heat banks” (thermally insulated volumes of sea water around production equipment for mitigation of hydrate formation) which offer opportunities to heat the fuel cell input gases/fluids by virtue of the excess heat available. Thus there are many sources of energy suitable for alignment of input gases/fluids to fuel cell operating conditions.

Use of pressure vessels 31, 31′ in a sub sea environment 17 are proven from sub sea separation applications where typically 500 MPa carbon steel qualities have been successfully applied to construction of large pressure vessels. Such pressure vessels 31, 31′ have been successfully clad internally with high alloy steels and equipped with sacrificial anodes and coating on the outside for corrosion protection.

The sub sea oil and gas industry has been very successful in constructing, installing on the sea bed and operating, all dimensions of tubulars from ¼ inch small bore tubing in umbilicals to 42 inch heavy pipe for trunk lines. The common denominator has been that methods for economical design suitable for this type of environment have been found for all cases. Connections of such tubulars to a sub sea station have a very long record of successful designs.

For the case of providing supply of oxygen and hydrogen by means of tubes/pipes there could be typically two distinct scenarios:
Use of small bore tubing in a control/chemicals umbilical, typically for small mass transfer rates (not shown)
Use of separate pipes 1, 2 with external walls directly exposed to the ambient water 17 (typically for large mass transfer rates)

Alternatively, the oxidizer could be conducted in a pipe/tube and the hydrogen or oxidizing agent could be stored in a pressure vessel on location.

It is a characteristic feature of hydrogen gas, H₂, that the molecules are very small and tend to permeate through the walls of any type of metal tubular, irrespective of its production method. This introduces a challenge with respect to handling of H₂ lines 1 with high partial pressures of hydrogen. For instance, transport of H₂ gas at 300 bara pressure would represent a very high partial pressure of hydrogen and would lead to permeation of hydrogen through the pipe 1 wall irrespective of pressure and substance on the outside of that pipe wall.

For the second scenario above this is not a problem, since loss of minor quantities of hydrogen gas to the ambient is considered to be neither an economical nor an environmental problem.

For the first scenario above migration of gas from an H₂ line in an umbilical to the other elements in the umbilical (electrical power lines, optical fibres, chemical lines, and especially to a line carrying oxygen) are considered undesirable and possibly prohibitive.

In order to provide a solution for the umbilical scenario a pipe-in-pipe arrangement (not shown) can be introduced. This approach would be based on the H₂ gas being conducted in an inner tube, embedded concentrically in an outer tube, the annulus carrying a certain flow of an auxiliary fluid such as sea water, which is naturally unsaturated with hydrogen in the free H₂ form, for the purpose of removing H₂ molecules permeating through the walls of the inner tube. Pipe-in-pipe technology is well established in the sub sea oil and gas industry, even for quite large dimensions of pipe. The pipes are firmly fixed to each other at certain intervals and the complete assembly may be installed by a reeling method.

From the fuel cell electrical cables conduct a low voltage DC current through penetrators 35 and a conductive wet mate connector 36 to DC/AC converter 37 located in a pressure vessel. Wet mate connectors are well proven for lower voltages.

In another preferred embodiment of the invention pressure containers (not shown) are used at the production station to store compressed oxygen and hydrogen for supply of the fuel cell.

The invention is of course not in any way restricted to the preferred embodiments described above. On the contrary, many possibilities to modifications thereof will be apparent to a person with ordinary skill in the art without departing from the basic idea of the invention.

### DRAWING REFERENCES

1 feed line for oxidizing fluid
2 feed line for oxidizer
3 combustion chamber
4 turbine
5 compressor
6 flow line for production fluid (produced gas)
7 flow line for production fluid (high pressure gas)
8 (non-used)
9 heat exchanger/separator pipe
10 heat exchanger/separator
11 line for discharge of separated liquid phase from heat exchanger/separator
12 pump
13 flow line
14 in-feed of water upstream of turbine
15 (non-used)
16 (non-used)
17 ambient sea
18 discharge pipe
19, 20 (non-used)
21 feed line for hydrogen
22 feed line for oxygen
23, 24 (non-used)
25 combustion chamber
26 heat exchanger
27 well stream
28 flow line
29 check valve
30 fuel cell
31 pressure vessel
31′ pressure vessel
32 waste water output
33 heat exchanger
34 heat exchanger
35 penetrator
36 wet mate connector
37 DC/AC converter

1. A method for generating power at sub sea level, for driving sub sea processes or/and sub sea production equipment, the method comprising:
feeding hydrogen and oxygen separately to a combustion chamber located at a sub sea station, wherein the hydrogen and oxygen are mixed and combusted into combustion gases under the release of energy, and
feeding the energy so produced for powering at least one of:
a compressor or a pump operative for boosting the pressure of a hydrocarbon product stream in a flow line from an oil well and/or a gas well, or
a heat exchanger operative for transferring heat from combustion gases to a hydrocarbon product stream in a flow line from an oil well and/or a gas well.

2. The method according to claim 1, further comprising:
discharging combustion gases to an inlet of a steam turbine connected as drive mechanism to a compressor or pump.

3. The method according to claim 2, further comprising:
discharging combustion gases from the turbine into a separator unit, and removing a liquid water phase from the combustion gases.

4. The method according to claim 3, further comprising:
mixing the separated liquid water phase into the combustion gases such that steam is produced upstream of the turbine inlet.

5. An apparatus for generating power at sub sea level for driving sub sea processes or/and sub sea production equipment, the apparatus comprising:
supply lines for separate feed of hydrogen and oxygen to a combustion chamber located at a sub sea station, wherein the hydrogen and oxygen are mixed and combusted into combustion gases under the release of energy, wherein the combustion gases are discharged from an outlet of the combustion chamber for powering at least one of:
a compressor or a pump operative for boosting the pressure of a hydrocarbon product stream in a flow line from an oil well and/or a gas well, or
a heat exchanger operative for transferring heat from combustion gases to a hydrocarbon product stream in a flow line from an oil well and/or a gas well.

6. The apparatus according to claim 5, wherein the hydrogen and oxygen are supplied from a land-based station or from a host platform at sea surface.

7. The apparatus according to claim 5, wherein the outlet from combustion chamber is connected to an inlet of a turbine, the turbine being connected as drive mechanism to a compressor or pump which is in flow communication with a hydrocarbon product stream.

8. The apparatus according to claim 7, wherein an outlet from the turbine is connected to a heat exchanger.

9. The apparatus according to claim 7, wherein an outlet from the turbine is connected to a separator unit operative for separating a liquid water phase from the combustion gases.

10. The apparatus according to claim 9, wherein the separator is in flow communication with the discharge of combustion gases from the combustion chamber, and operative for introducing water in the combustion gases upstream of the turbine inlet.

11. The apparatus according to claim 10, wherein the separator has essentially vertical heat exchanger pipes penetrating an upper portion of a pressure vessel forming a separator/heat exchanger shell such that the heat exchanger pipes form closed volumes, filled with a substance suitable for liquid/gas phase conversion at the temperatures prevailing in the separator/heat exchanger volume, and suitable for the reverse process at temperatures in the range of the ambient, such that at least one, preferably each of the sealed pipes constitute a separate heat exchanger system without moving parts.

12. Use of hydrogen and oxygen for power production at sub sea level according to the method of claim 1.

13. Use of hydrogen and oxygen for power production at sub sea level according to the method of claim 1 to enhance the flow of hydrocarbons through a flow line in the sub sea production of oil and/or gas.
